(19) United States
(12) Patent Application Publication
(10) Pub. No.: US 2007/0208478 A1
(43) Pub. Date: Sep. 6, 2007

(54) Vehicle control apparatus and method

(75) Inventor: Hideki Takamatsu, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi (JP)

(21) Appl. No.: 11/708,638

(22) Filed: Feb. 21, 2007

(30) Foreign Application Priority Data
Mar. 1, 2006 (JP) 2006-054855

(51) Int. Cl. G06F 17/00

(52) U.S. Cl. 701/53; 701/51

(57) ABSTRACT

A vehicle control apparatus and method that control a vehicle equipped with a driving source and an automatic transmission connected to the driving source are provided. The vehicle control apparatus and method increase a driving force by at least one of the increase in output from the driving source and the increase in a speed ratio of the automatic transmission, when the vehicle is traveling. The vehicle control apparatus and method detects a request for passing a lead vehicle, and performs a limit control when the request for passing the lead vehicle is detected. The limit control reduces a proportion of the driving force increased by the increase in the speed ratio of the automatic transmission to the driving force increased by the increase in the output from the driving source.

### INCORPORATION BY REFERENCE

The disclosure of Japanese Patent Application No. 2006-54855 filed on Mar. 1, 2006 including the specification, drawings and abstract is incorporated herein by reference in its entirety.

### BACKGROUND OF THE INVENTION

1. Field of the Invention

The invention relates to a control apparatus and method of a vehicle equipped with an automatic transmission. The invention particularly relates to a control apparatus and method that reflects a driver's intention to accelerate the vehicle when the vehicle is passing the lead vehicle.

2. Description of the Related Art

The automatic transmission that is mounted on a vehicle includes a transmission mechanism that is connected to an engine via a torque converter and other components and includes a plurality of power transmission paths. The automatic transmission, for example, automatically shifts power transmission paths based on a throttle opening and a vehicle speed, that is, the automatic transmission automatically shifts speeds. A vehicle with the automatic transmission in general is provided with a shift lever that is operated by the driver, and shift positions (e.g. a reverse position, a neutral position, and forward position) are set according to the shift lever operation. The automatic shift control is performed to change speed within one of the shift positions, normally within the forward position, set as aforementioned.

Normally, at the forward position selected when the vehicle is traveling, shift control is performed based on a shift line (shift map) determined according to the vehicle speed and the throttle opening. The shift line is set separately for upshifting and downshifting. If a shift line the same as that of downshifting is used for upshifting, for example, after the vehicle speed increases and the transmission upshifts, the vehicle speed decreases, crosses the shift line, and the transmission thus downshifts. When the transmission downshifts, the vehicle speed again increases and the transmission upshifts. In summary, the problem of gear hunting arises. Gear hunting is the state where the transmission repeatedly and alternately upshifts and downshifts near the set shift line. In order to avoid such gear hunting, for example, the upshift line is matched with the fuel efficiency optimal line or the optimal line for the exhaust gas purification, and the downshift line is located in the lower speed side than the upshift line.

Further, when the vehicle is passing the lead vehicle while traveling in the driving lane of an expressway, the driver steers the vehicle to move to the passing lane and also depresses an accelerator pedal to request for producing a relatively large acceleration. During this, the transmission normally downshifts according to the shift map to accelerate the vehicle, that is, the shift control of the automatic transmission is performed according to the driver's intention to accelerate the vehicle.

Japanese Patent Application Publication No. H9-79362 (No. JP-A-H9-79362) discloses a shift control apparatus of a vehicle automatic transmission that learns driving preference of the driver, estimates the driver's intention, and changes speed. The shift control apparatus includes driving operation learning means, target speed setting means, fuzzy rule detecting means, and setting means. The driving operation learning means learns the driving operations corresponding to the individual characteristics of the driver from driving information input based on the driving operation of the driver. The target speed setting means sets a target speed based on at least the vehicle speed and engine load information. The fuzzy rule detecting means outputs correction data determined according to a desired fuzzy rule when the desired fuzzy rule is satisfied using the vehicle information as a parameter. The vehicle information functioning as the parameter includes at least vehicle load information. The setting means corrects the target speed based on information output from the driving operation learning means and information output from the fuzzy rule detecting means, and sets an optimal speed that reflects the driver's intention. The fuzzy rule mentioned above is the rule in which the transmission downshifts when the vehicle is estimated to be passing the lead vehicle based on driving information of the vehicle, even if the current speed and the target speed are the same.

According to the shift control apparatus, the following advantages are realized. The automatic shifting that fully reflects preferences and intention of the driver can be realized. Further, the transmission changes the speed to the optimal speed for the load condition of the vehicle, and therefore drivability is significantly improved. When the vehicle is estimated to be passing the lead vehicle based on the driving information of the vehicle, the vehicle is smoothly accelerated according to the fuzzy rule in which the transmission downshifts even if the current speed and the target speed are the same.

As mentioned above, when the vehicle is passing the lead vehicle while traveling in the driving lane of the expressway, it is most likely that the driver steers the vehicle to move to the passing lane, accelerates the vehicle to pass the lead vehicle, and finally, steers the vehicle to promptly return to the driving lane.

In such a case, according to the shift control apparatus described in Japanese Patent Application Publication No. H9-79362 (No. JP-A-H9-79362), the estimation is made that the vehicle is currently traveling in the passing lane, and the transmission downshifts based on the estimation. Subsequently, when the vehicle returns to the driving lane, the transmission upshifts in order to recover the optimal speed. As a result of this, gear hunting occurs and the driver may feel that drivability of the vehicle deteriorates.

### SUMMARY OF THE INVENTION

The invention provides a vehicle control apparatus and method that avoids deterioration of drivability when the vehicle is passing the lead vehicle and reflects the driver's intention to accelerate the vehicle.

According to a first aspect of the invention, a vehicle control apparatus that controls a vehicle equipped with a driving source and an automatic transmission connected to the driving source is provided. The vehicle control apparatus increases the driving force by at least one of the increase in output from the driving source and the increase in the speed ratio of the automatic transmission when the vehicle is traveling. The vehicle control apparatus includes a detecting unit that detects a request for passing a lead vehicle made by a driver, and a control unit that performs a speed ratio change limit control when the request for passing the lead vehicle is detected. The speed ratio change limit control reduces a proportion of the driving force increased by the increase in the speed ratio of the automatic transmission to the driving force increased by the increase in the output from the driving source.

According to the first aspect, in the vehicle including a driving source such as an engine or a motor and, for example, a gearshift automatic transmission, the driving force is temporarily increased to accelerate the vehicle, when the vehicle passes the lead vehicle. The driving force may be increased by increasing the output from the driving source and/or increasing the speed ratio of the automatic transmission (e.g. changing gear to increase the gear ratio). However, when this temporary increase of the driving force becomes unnecessary after passing the lead vehicle, if the speed ratio of the automatic transmission is increased(e.g. the transmission has downshifted to increase the gear ratio), the transmission then upshifts to recover the gear ratio before downshifting. Thus, gear hunting occurs. Therefore, in this case, the proportion of the increase in the driving force produced by the increased speed ratio of the automatic transmission to the increase in the driving force produced by the increased output from the driving source is reduced. For example, in order to reduce the proportion, downshifting may be prohibited, and the output from the driving source may be increased so as to achieve the desired acceleration when passing the lead vehicle. As a result, deterioration of drivability can be avoided when the vehicle is passing the lead vehicle, and the driver's intention to accelerate the vehicle can be satisfied.

The automatic transmission may include a gearshift transmission mechanism, and the speed ratio may be increased by downshifting. The control unit does not perform the downshifting and increases the output from the driving source when the request for passing the lead vehicle made by the driver is detected.

In this manner, the vehicle is accelerated when passing the lead vehicle by increasing the output from the driving source, such as the engine and the motor, without downshifting by the gearshift automatic transmission. Therefore, the transmission does not upshift after the vehicle passes the lead vehicle, thus avoiding gear hunting. As a result, deterioration of drivability can be avoided.

The detecting unit may determine whether the vehicle is traveling in either of a driving lane or a passing lane and detect the request for passing the lead vehicle made by the driver by detecting the lane change from the driving lane to the passing lane.

The control unit may terminate the speed ratio change limit control when the vehicle is traveling in the driving lane after the lane change from the passing lane to the driving lane.

Therefore, if the vehicle passes the lead vehicle and then returns from the passing lane to the driving lane, the speed ratio change limit control is terminated, and the normal driving control is resumed.

The control unit may terminate the speed ratio change limit control when the vehicle is continuously traveling in the passing lane.

When the vehicle is traveling in the passing lane, since it is unlikely that the driver intends to pass the lead vehicle, the speed ratio change limit control is terminated, and the normal driving control is resumed.

The vehicle control apparatus further includes a rapid acceleration detecting unit that detects a request for rapid acceleration made by the driver. The control unit may prohibit the speed ratio change limit control when the request for rapid acceleration is detected.

When the request for rapid acceleration is made, only increasing the output of the driving source, such as the engine or motor, may not accelerate the vehicle as it is required. Therefore, the shift ratio change limit control is prohibited in order to achieve the required acceleration. This makes it possible to further increase the driving force by downshifting.

A second aspect of the present invention provides a vehicle control apparatus that controls a vehicle having a driving source and an automatic transmission connected to the driving source. The vehicle control apparatus includes a driving source control unit that increases a driving force by an increase in output from the driving source, a speed ratio control unit that increases the driving force by an increase in a speed ratio, a detecting unit that detects a lane change of a vehicle from a driving lane to a passing lane, and a control unit that performs the speed ratio change limit control when the lane change from the driving lane to the passing lane is detected. The speed ratio change limit control reduces a proportion of the driving force increased by the increase in a speed ratio of the automatic transmission to the driving force increased by the increase in output from the driving source.

A third aspect of the present invention provides a vehicle control method that controls a vehicle having a driving source and an automatic transmission connected to the driving source, and increases a driving force by at least one of an increase in output from the driving source and an increase in the speed ratio of the automatic transmission when the vehicle is traveling. The vehicle control method detects a request for passing a lead vehicle made by a driver, and performs the speed ratio change limit control when the request for passing the lead vehicle is detected.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram showing a powertrain of a vehicle to which a vehicle control apparatus according to an embodiment of the present invention is applied.

FIG. 2 is a block diagram showing the ECU 1000 shown in FIG. 1.

FIGS. 3A and 3B are flowcharts showing a routine of the processes performed by the powertrain control unit 1300 shown in FIG. 2.

FIG. 4 is a timing diagram showing a change in a required throttle opening over time.

FIG. 5 is a graph showing the changed shift line.

FIG. 6 is a view illustrating how the vehicle travels.

FIG. 7 is a view illustrating how the vehicle travels.

### DETAILED DESCRIPTION OF THE PREFERRED EMBODIMENTS

The preferred embodiment of the invention will be described with reference to the attached drawings. In the descriptions herein, the same components are denoted by the same reference numerals, and the components with the same reference numeral have the same name and function. Therefore, the description thereof will not be repeated.

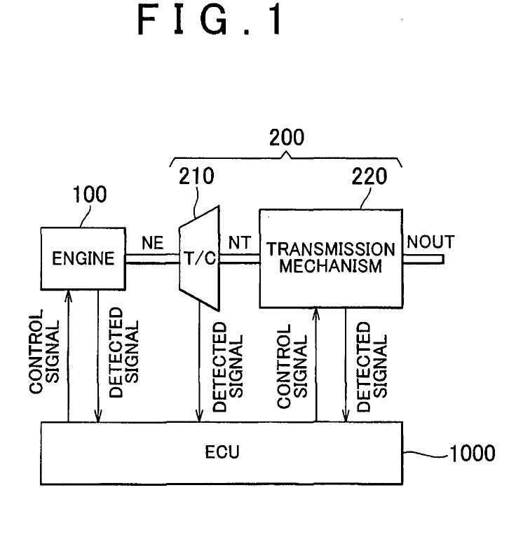

FIG. 1 shows a powertrain of a vehicle to which a vehicle control apparatus (hereinafter simply referred to as a “control apparatus” where appropriate) according to an embodiment of the present invention is applied.

As shown in FIG. 1, the vehicle includes an engine 100, an automatic transmission 200, and an electronic control unit (ECU) 1000. The automatic transmission 200 includes a torque converter 210 and a transmission mechanism 220. The ECU 1000 controls operations of the engine 100 and the automatic transmission 200. The driving source in the invention is not limited to the engine 100 and may be a motor, such as a motor generator.

An accelerator pedal sensor outputs a signal indicative of an operation amount of an accelerator pedal to the ECU 1000. The ECU 1000 also receives a signal from a brake switch, which detects that the driver depresses the foot brake, and also receives a signal indicative of steering operation. Further, current position of the running vehicle is input to the ECU 1000 from a navigation device 1200.

The automatic transmission 200 includes a fluid coupling such as the torque converter 210, and a transmission mechanism such as a gearshift mechanism, a belt continuously variable transmission (CVT), and a traction CVT. The transmission mechanism 220 in this embodiment employs the gearshift transmission.

The torque converter 210 serving as the fluid coupling includes a pump 212 (e.g. pump impeller) that is attached in the engine 100 side and a turbine 214 (e.g. turbine runner) that is attached in the transmission mechanism 220 side. Since the torque converter 210 has the conventional construction, the detailed description thereof will be omitted.

When the vehicle is passing the lead vehicle while traveling on an expressway, the ECU 1000 changes a throttle opening to control a torque output from the engine 100. The ECU 1000 also controls the automatic transmission 200 by outputting a signal to solenoid valves to produce the desired speed by engaging or releasing friction engagement elements of the transmission mechanism 220 according to the shift map.

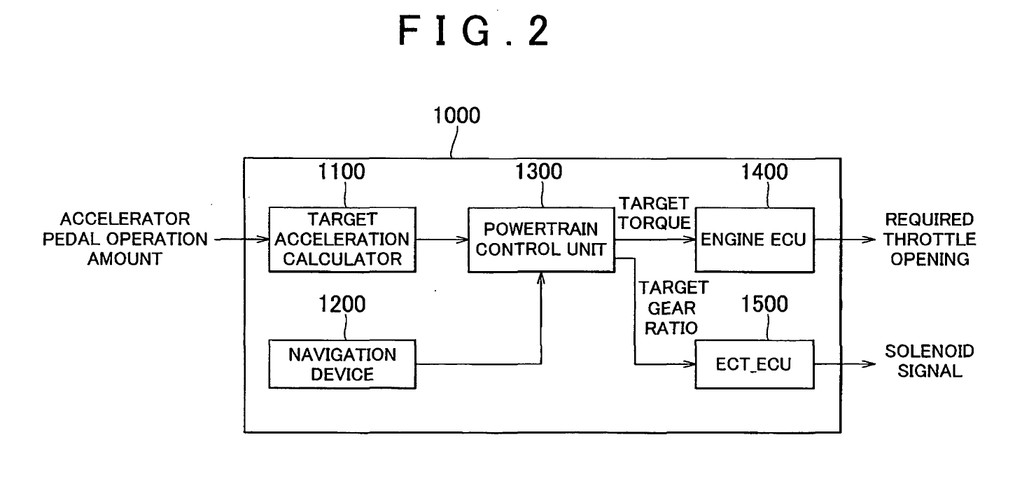

FIG. 2 is a block diagram showing the ECU 1000 shown in FIG. 1 in detail. FIG. 2 shows only the components and operations related to the control to avoid gear hunting occurring when the vehicle is accelerated to pass the lead vehicle while traveling on the expressway.

As shown in FIG. 2, the ECU 1000 includes an engine control unit (engine ECU) 1400 and an electronically controlled automatic transmission control unit (ECT_ECU) 1500. The engine ECU 1400 controls the engine 100, and the ECT_ECU 1500 controls the automatic transmission 200. The engine ECU 1400 outputs a signal indicative of a required throttle opening to the engine 100 so as to control output from the engine 100. The ECT_ECU 1500 outputs a solenoid signal (control signal) to the automatic transmission 200 to control gear shifting operations of the automatic transmission 200.

The operation amount of the accelerator pedal is input to a target acceleration calculator 1100, and the target acceleration calculator 1100 calculates the target acceleration. The calculated target acceleration is input to a powertrain control unit 1300. The powertrain control unit 1300 receives information regarding the vehicle position from the navigation device 1200 to determine whether the vehicle is traveling on the expressway, and if so, determines whether the vehicle is traveling in the passing lane or the driving lane. The powertrain control unit 1300 performs the control to avoid gear hunting when the vehicle is accelerated to pass the lead vehicle on the expressway. In the control, the powertrain control unit 1300 outputs a signal indicative of a target torque to the engine ECU 1400 and also outputs a signal indicative of a target gear ratio to the ECT_ECU 1500.

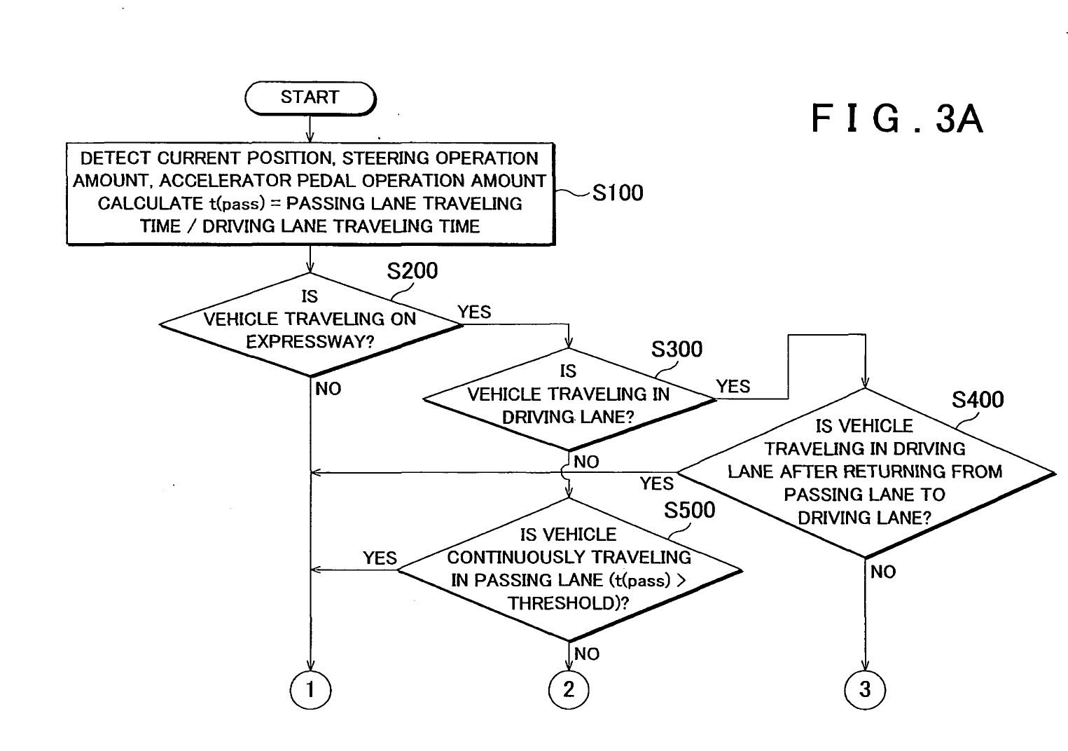

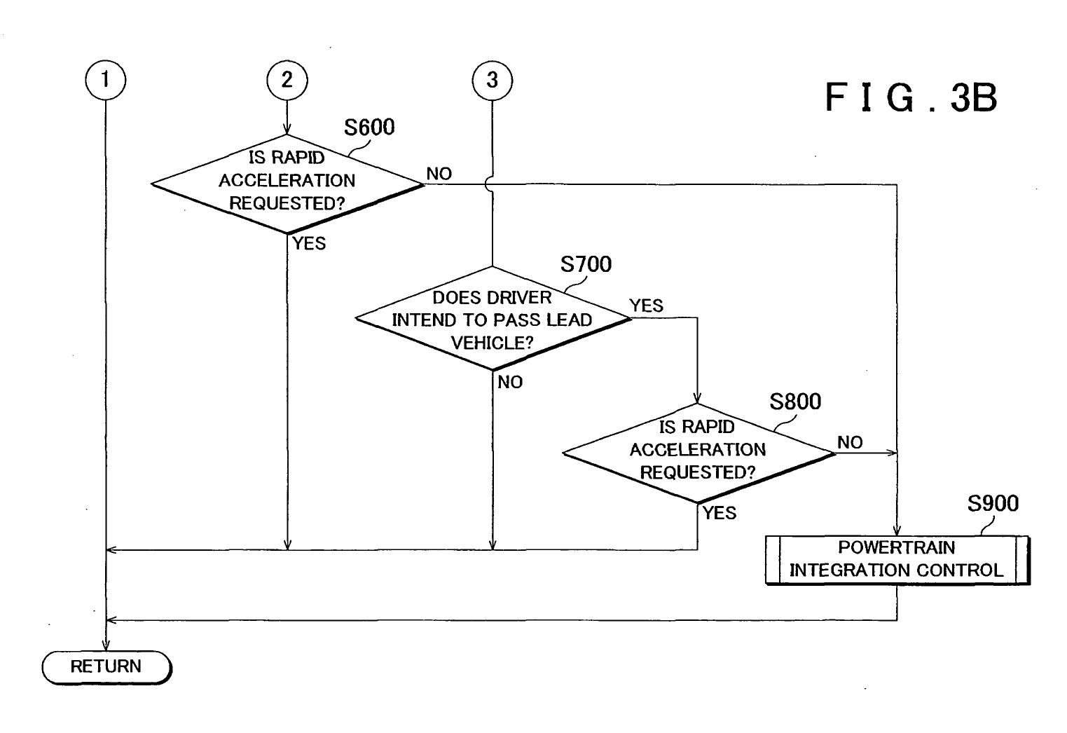

Referring to the flowcharts shown in FIGS. 3A and 3B, the control process to avoid gear bunting when the vehicle is accelerated to pass the lead vehicle on the expressway will be described. The control process to avoid gear hunting is repeatedly performed by the powertrain control unit 1300 at a predetermined interval.

In step (hereinafter abbreviated as “S”) 100, the powertrain control unit 1300 detects the current position of the vehicle, steering operation amount, and accelerator pedal operation amount. The powertrain control unit 1300 also calculates a value of t(pass) indicating the proportion of time during which the vehicle is continuously traveling in the passing lane (“passing lane traveling time”) to time during which the vehicle travels in the driving lane (“driving lane traveling time”) by dividing the passing lane traveling time by the driving lane traveling time (the passing lane traveling time/driving lane traveling time).

In S200, the powertrain control unit 1300 determines whether the vehicle is traveling on the expressway. The determination in S200 is made based on the information input from the navigation device 1200. The information may include the current position of the vehicle and map information, or expressway traveling information. If it is determined that the vehicle is traveling on the expressway, that is, the determination is YES in S200, the process proceeds to S300. If not, that is, the determination is NO in S200, the process ends. During this time, if a powertrain integration control, which will be described later in the specification, is being performed, the powertrain integration control is terminated, and the normal driving control is resumed.

In S300, the powertrain control unit 1300 determines whether the vehicle is traveling in the driving lane. The determination in S300 is made based on the information input from the navigation device 1200. The information may include the current position of the vehicle and map information, or driving lane traveling information. If it is determined that the vehicle is traveling in the driving lane, that is, the determination is YES in S300, the process proceeds to S400. If not, that is, the determination is NO is S300, the process proceeds to S500.

In S400, the powertrain control unit 1300 determines whether the vehicle is currently traveling in the driving lane after the vehicle, which has been traveling in the passing lane, returns from the passing lane to the driving lane. The determination in S400 is also made based on the information input from the navigation device 1200. If it is determined that the vehicle is traveling in the driving lane after returning from the passing lane to the driving lane, that is, the determination is YES in S400, the process ends. In other words, if the powertrain integration control is being performed, the powertrain integration control is terminated, and the normal driving control is resumed. If not, that is, the determination is NO in S400, the process proceeds to S700.

In S500, the powertrain control unit 1300 determines whether the vehicle is continuously traveling in the passing lane. The determination in S500 may be made by determining whether the value of t(pass) is larger than a predetermined threshold. If t(pass) is larger than the predetermined value, this indicates that the vehicle is continuously traveling in the passing lane. If it is determined that the vehicle is continuously traveling in the passing lane, that is, the determination is YES in S500, the process ends. In other words, at this time, if the powertrain integration control is being performed, the powertrain integration control is terminated, and the normal driving control is resumed. If not, that is, the determination is NO in S500, the process proceeds to S600.

In S600, the powertrain control unit 1300 determines whether the driver requests for rapid acceleration. The determination in S600 may be made by determining whether the amount of change in the accelerator pedal operation or the time derivative of the amount of change in the accelerator pedal operation is larger than a predetermined threshold. If it is determined that the driver requests for rapid acceleration, that is, the determination is YES in S600, the process ends. In other words, since the driver requests for rapid acceleration, the powertrain integration control is prohibited giving the priority to achievement of the requested acceleration over avoidance of gear hunting. If not, that is, the determination is NO in S600, the process proceeds to S900.

In S700, the powertrain control unit 1300 determines whether the driver intends to pass the lead vehicle. The determination in S700 is made based on the vehicle condition and the operation amount by the driver. If it is determined that the driver intends to pass the lead vehicle, that is, the determination is YES in S700, the process proceeds to S800. If not, that is, the determination is NO in S700, the process ends. In other words, at this time, if the powertrain integration control is being performed, the powertrain integration control is terminated, and the normal driving control is resumed.

In S800, the powertrain control unit 1300 determines whether the driver requests for rapid acceleration. The determination in S800 may be made by determining whether the amount of change in the accelerator pedal operation and the time derivative of the amount of change in the accelerator pedal operation are larger than predetermined thresholds, as in S600. It should be noted that the predetermined threshold used in S800 differs from the predetermined threshold used in S600. If it is determined that the driver requests for rapid acceleration, that is, the determination is YES in S800, the process ends. In other words, since the driver requests for rapid acceleration, the powertrain integration control is not performed giving the priority to achievement of the requested acceleration over avoidance of gear hunting. If not, that is, the determination is NO in S800, the process proceeds to S900.

In S900, the powertrain control unit 1300 performs the powertrain integration control, which is the control to limit a change in the gear ratio. The power train integration control may be regarded as an example of a speed ratio change limit control. In the powertrain integration control, downshifting is not performed (prohibited), and instead of downshifting, the vehicle is accelerated by increasing the output from the engine 100 to avoid gear hunting occurring when the vehicle is accelerated for passing.

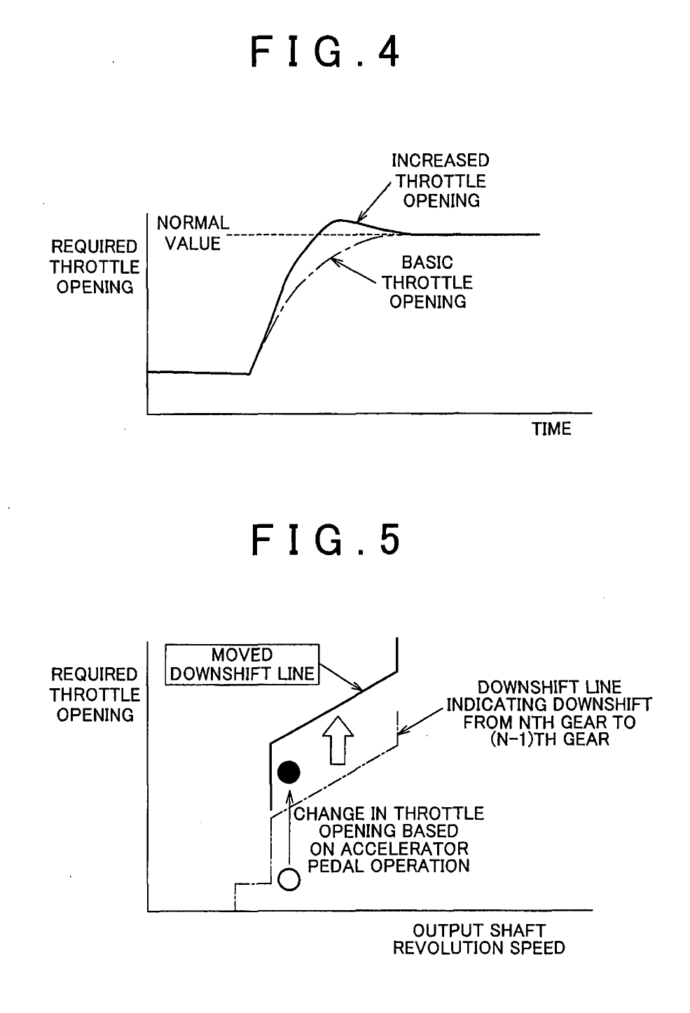

For example, as shown in FIG. 4, the increased throttle opening is set to be larger than the basic throttle opening corresponding to the accelerator pedal operation amount for normal driving. The increased throttle opening is the throttle opening to achieve the acceleration of the vehicle by increasing the output of the engine without downshifting. In FIG. 4, the increased throttle opening is shown by a solid line, and the basic throttle opening is shown by a dashed line. The engine ECU 1400 outputs the increased throttle opening to the engine 100 as the required throttle opening. In this way, the engine 100 produces larger output than the normal output, which is produced according to the depression amount of the accelerator pedal by the driver. The throttle opening in the control (shown by the solid line) is set so that the output from the engine 100 is large enough to accelerate the vehicle to pass the lead vehicle without downshifting.

Further, as shown in FIG. 5, the downshift line indicating downshifting from the Nth gear to the (N−1)th gear, which is shown by a dashed line, may be moved upward (in the direction increasing the throttle opening) in the drawing as shown by a solid line. In this way, if the required throttle opening is increased from the value shown by a circle toward the value shown by a filled circle based on the accelerator pedal operation by the driver, the increase in the required throttle opening does not cross the moved downshift line. This means that downshifting is not performed even if the required throttle opening is increased. Note that, for this purpose, the required throttle opening for changing speed may be corrected so as to be smaller than the basic throttle opening, instead of moving the downshift line upward as shown in FIG. 5. For example, the required throttle opening for changing speed may be calculated by deducting a predetermined correction value from the basic throttle opening.

The operations of the vehicle, which is controlled by the ECU 1000 serving as the vehicle control apparatus according to the embodiment of the invention, will be described. These operations are performed based on the aforementioned construction and the aforementioned flowchart. Note that, the operations will be described separately for each of the following cases: (1) the vehicle traveling in the passing lane is passing the lead vehicle; (2) the vehicle traveling in the driving vehicle is passing the lead vehicle; (3) the vehicle has returned from the passing lane to the driving lane; (4) the vehicle is continuously traveling in the passing lane; and (5) the vehicle is required for rapid acceleration regardless of traveling in the driving lane or traveling in the passing lane.

The Case (1): the Vehicle Traveling in the Passing Lane is Passing the Lead Vehicle

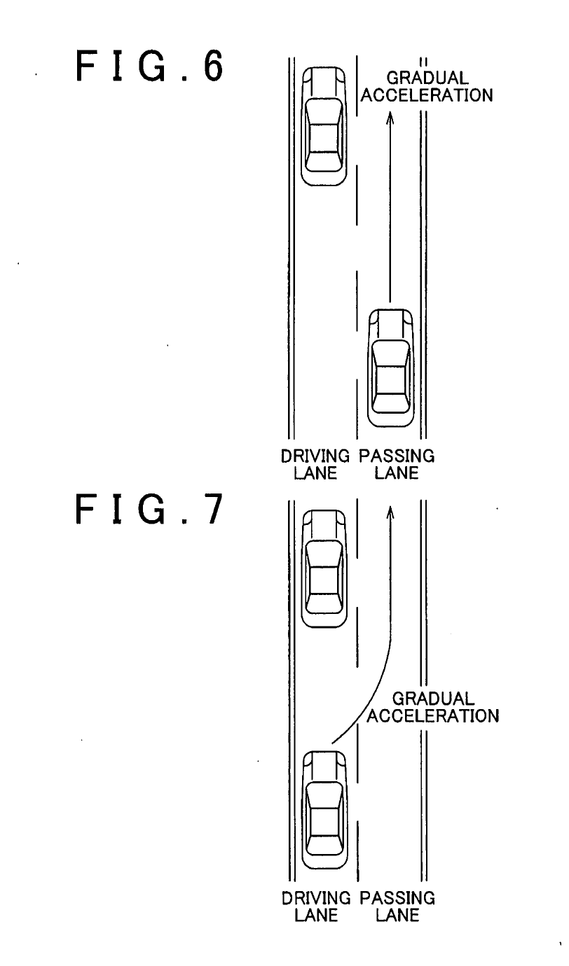

If the vehicle is traveling on the expressway (YES in S200), and is not traveling in the driving lane (NO in S300), it is determined in S500 whether the vehicle is continuously traveling in the passing lane. If the vehicle is not continuously traveling in the passing lane (NO in S500), that is, a predetermined time has not elapsed since the lane change from the driving lane to the passing lane (the value t(pass) is equal to or smaller than a threshold), it is determined in S600 whether rapid acceleration is requested. In case of gradual acceleration (NO in S600), the powertrain integration control is performed in S900, and the throttle opening is set to be larger than the basic throttle opening shown in FIG. 4, and/or the downshift line is changed upward as shown in FIG. 5, that is, the downshift line is changed so that downshifting is avoided. In this case, the vehicle travels in the manner as shown in FIG. 6.

In this way, the vehicle can be accelerated by the increased output from the engine 100 without downshifting of the automatic transmission 200, and therefore the upshifting of the automatic transmission 200 does not occur after downshifting. As a result, gear hunting can be avoided.

The case (2): the Vehicle Traveling in the Driving Vehicle is Passing the Lead Vehicle

If the vehicle is traveling on the expressway (YES in S200), and the vehicle is traveling in the driving lane (YES in S300), it is determined in S400 whether the vehicle is currently traveling in the driving lane after the vehicle, which has been traveling in the passing lane, returns from the passing lane to the driving lane. If is continuously traveling in the driving lane without having traveled in the passing lane (NO in S400), it is determined in S700 whether the driver intends to pass the lead vehicle. For example, since the vehicle is traveling in the driving lane (YES in S300), if the vehicle changes the lane from the driving lane to the passing lane, it is determined that the driver intends to pass the lead vehicle (YES in S700). Then it is determined in S800 whether rapid acceleration is requested. In case of gradual acceleration (NO in S800), the powertrain integration control is performed in S900, and the throttle opening is set larger than the basic throttle opening as shown in FIG. 4, and/or the downshift line is moved upward as shown in FIG. 5, that is, the downshift line is changed so that downshifting is avoided. In this case, the vehicle travels in the manner as shown in FIG. 7.

In this way, the vehicle can be accelerated by the increased output from the engine 100 without downshifting of the automatic transmission 200, and therefore the upshifting of the automatic transmission 200 does not occur after downshifting. As a result, gear hunting can be avoided.

The Case (3): the Vehicle has Returned from the Passing Lane to the Driving Lane

If the vehicle returns from the passing lane to the driving lane after moving from the driving lane to the passing lane and then passing the lead vehicle as described in the case (2) (YES in S300), it is determined in S400 whether the vehicle is traveling in the driving lane after returning from the passing lane. Since it is determined that the vehicle is traveling in the driving lane after returning from the passing lane (YES in S400), the control to avoid gear hunting is terminated.

The Case (4): the Vehicle is Continuously Traveling in the Passing Lane

If the vehicle is not traveling in the driving lane, that is, the vehicle is traveling in the passing lane (NO in S300), it is determined in S500 whether the vehicle is continuously traveling in the passing lane. Since it is determined that the vehicle is traveling in the passing lane (YES in S500), that is, the predetermined time has elapsed since the lane change from the driving lane to the passing lane (the value t(pass) is larger than a threshold), the control to avoid gear hunting is terminated.

The case (5): the Vehicle is Required for Rapid Acceleration Regardless of Traveling in the Driving Lane or Traveling in the Passing Lane

If rapid acceleration is requested (YES in S800) while the vehicle is traveling in the driving lane (YES in S300), or if rapid acceleration is requested (YES in S600) while the vehicle is traveling in the passing lane (NO in S300), the control to avoid gear hunting is terminated so that the powertrain integration control is prohibited. In this case, since rapid acceleration is requested, the powertrain integration control is not performed giving priority to achievement of the requested acceleration over avoidance of gear hunting.

As described above, in the case where the vehicle passes the lead vehicle by gradual acceleration after changing the lane from the driving lane to the passing lane, or in the case where the vehicle is gradually accelerated in the passing lane to pass the lead vehicle in the driving lane, the engine output is increased and/or the downshift line in the shift diagram is changed so that downshifting is avoided. In summary, the control is performed giving the priority to avoidance of gear hunting over pursuit of the acceleration performance. As a result, drivability can be improved.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

What is claimed is:

1. A vehicle control apparatus that controls a vehicle equipped with a driving source and an automatic transmission connected to the driving source, and increases a driving force by at least one of an increase in output from the driving source and an increase in a speed ratio of the automatic transmission when the vehicle is traveling, the vehicle control apparatus comprising:
a detecting unit that detects a request for passing a lead vehicle made by a driver; and
a control unit that performs a speed ratio change limit control when the request for passing the lead vehicle is detected, the speed ratio change limit control reducing a proportion of the driving force increased by the increase in the speed ratio of the automatic transmission to the driving force increased by the increase in the output from the driving source.

2. The vehicle control apparatus according to claim 1, wherein
the automatic transmission includes a gearshift transmission mechanism, and the speed ratio is increased by downshifting; and
the control unit does not perform the downshifting and increases the output from the driving source when the request for passing the lead vehicle is detected.

3. The vehicle control apparatus according to claim 2, wherein
the control unit increases the output from the driving source by increasing a throttle opening from a basic throttle opening corresponding to a normal driving control.

4. The vehicle control apparatus according to claim 2, wherein
the control unit moves a shift line of the speed ratio of the gearshift transmission mechanism in a direction increasing a throttle opening to prohibit the downshifting.

5. The vehicle control apparatus according to claim 1, wherein the detecting unit determines whether the vehicle is traveling in either of a driving lane or a passing lane, and detects the request for passing the lead vehicle by detecting a lane change from the driving lane to the passing lane.

6. The vehicle control apparatus according to claim 5, wherein the control unit terminates the speed ratio change limit control when the vehicle is traveling in the driving lane after a lane change from the passing lane to the driving lane.

7. The vehicle control apparatus according to claim 5, wherein the control unit terminates the speed ratio change limit control when the vehicle is continuously driving in the passing lane.

8. The vehicle control apparatus according to claim 1, further comprising:
a rapid acceleration detecting unit that detects a request for rapid acceleration, wherein the control unit prohibits the speed ratio change limit control when the request for rapid acceleration is detected.

9. The vehicle control apparatus according to claim 8, wherein the rapid acceleration detecting unit detects the request for rapid acceleration according to an amount of change in the accelerator pedal operation.

10. A vehicle control apparatus that controls a vehicle having a driving source and an automatic transmission connected to the driving source, the vehicle control apparatus comprising:
a driving source control unit that increases a driving force by an increase in output from the driving source;
a speed ratio control unit that increases the driving force by an increase in a speed ratio;
a detecting unit that detects a lane change of the vehicle from a driving lane to a passing lane; and
a control unit that performs a speed ratio change limit control when the lane change from the driving lane to the passing lane is detected, the speed ratio change limit control reducing a proportion of the driving force increased by the increase in the speed ratio of the automatic transmission to the driving force increased by the increase in the output from the driving source.

11. The vehicle control apparatus according to claim 10, wherein
the automatic transmission includes a gearshift transmission mechanism, and the speed ratio is increased by downshifting; and
the control unit does not perform the downshifting and increases the output from the driving source when the lane change from the driving lane to the passing lane is detected.

12. The vehicle control apparatus according to claim 10, wherein
the detecting unit detects the lane change from the driving lane to the passing lane according to a current position of the vehicle and map information.

13. A vehicle control method that controls a vehicle having a driving source and an automatic transmission connected to the driving source, and increases a driving force by at least one of an increase in output from the driving source and an increase in a speed ratio of the automatic transmission when the vehicle is traveling, the vehicle control method comprising:
detecting a request for passing a lead vehicle made by a driver; and
performing a speed ratio change limit control when the request for passing the lead vehicle is detected, the speed ratio change limit control reducing a proportion of the driving force increased by the increase in the speed ratio of the automatic transmission to the driving force increased by the increase in the output from the driving source.
